(19) United States
(12) Patent Application Publication
(10) Pub. No.: US 2018/0312436 A1
(43) Pub. Date: Nov. 1, 2018

(54) HYDRAULIC COMPOSITION HAVING IMPROVED CARBONATION RESISTANCE

(71) Applicant: HOLCIM TECHNOLOGY LTD, JONA (CH)

(72) Inventors: Alexandre JACQUEMIN, SAINT QUENTIN FALLAVIER (FR); Lê-Chiên HOANG, SAINT QUENTIN FALLAVIER (FR); Rémi BARBARULO, SAINT QUENTIN FALLAVIER (FR)

(21) Appl. No.: 15/769,544

(22) PCT Filed: Oct. 20, 2016
(86) PCT No.: PCT/FR2016/052709

§ 371 Date: Apr. 19, 2018

(30) Foreign Application Priority Data
Oct. 20, 2015 (FR) 1559981

(51) Int. Cl. C04B 24/28; C04B 28/04; C04B 14/34; C04B 14/28; C04B 14/06

(52) U.S. Cl. CPC C04B 24/28; C04B 28/04; C04B 2111/22; C04B 14/28; C04B 14/06; C04B 14/34

(57) ABSTRACT

A composition includes one hydraulic binder including at least one clinker, and at least one branched polyalkyleneimine, having a molecular weight between 400 g/mol and 1,000,000 g/mol, at a weight ratio polyalkyleneimine(s)/binder between 0.05% and 5.0%.

The present invention relates to the field of construction materials, and more particularly to a new, in particular hydraulic composition, having improved durability, in particular better carbonation resistance.

The durability of concretes or mortar structures obtained by hardening a hydraulic composition is a main issue. Indeed, a structure has to resist over time to various (physical, mechanical, chemical, . . . ) aggressions or stresses, that is to loads to which it is subjected, as well as to wind, rain, cold, heat or to the surrounding medium. The exposure to ambient atmosphere can cause carbonation of the material resulting from hardening a hydraulic composition. Indeed, the amount of water introduced into the hydraulic composition in the fresh state is often higher than the stoichiometric amount, which results in a porous medium, the pores of which are first filled with water. When the cement material dries, it becomes desaturated with water and the pores are partially filled with air. Atmospheric CO₂ thus diffuses into the hydrated hydraulic composition by its porosity and will react with cement hydrates, in particular with portlandite, to form calcium carbonate. There is thereby a decrease in pH which generally switches from value of 13 in the non-carbonated zone to a value generally lower than 9 in the carbonated zone. The pH of the degraded zone of the hardened hydraulic composition lowers and initiates steel corrosion in a wet medium and in the presence of oxygen.

In case of corrosion, rust is developed around steel bars and causes the coating composition to burst, which is of concern. The concrete from the hydraulic composition is thereby damaged and corrosion is all the more accelerated as the metal reinforcements are exposed.

Carbonation is in particular a major problem for low clinker level hydraulic compositions. Indeed, upon hardening, these hydraulic compositions are very sensitive to carbonation because of their low Portlandite level (a phase created upon hydrating a clinker, in particular a Portland clinker), this phase playing a buffer rule in the advance of carbonation.

In order to fulfill user requirements, it has become necessary to find means for reducing or preventing carbonation, and thus corrosion of metal elements when present in hydraulic compositions in the hardened state, in particular hydraulic compositions having a low clinker level and comprising mineral addition.

Thus, the problem the invention intends to solve is to provide a means for reducing or preventing carbonation, and thus corrosion of metal elements when present in hydraulic compositions in the hardened state, in particular hydraulic compositions having a low clinker level and comprising mineral addition. It is to be noted that the present invention attempts to reduce or prevent carbonation at a given degree of advance of hydration, which is characterised by a same compression mechanical strength (iso-strength). Without being bound by theory, it would seem indeed that carbonation is strongly related to the advance of hydration.

More precisely, the present invention relates to a composition comprising at least:

one hydraulic binder comprising at least one clinker, and

at least one branched polyalkyleneimine, having a molecular weight between 400 g/mol and 1,000,000 g/mol, at a weight ratio polyalkyleneimine(s)/binder between 0.05% and 5.0%.

Thus, unexpectedly, the inventors have highlighted that it is possible to use one (or more) polyalkyleneimine directly added in the bulk of the hydraulic composition to reduce and/or prevent carbonation of the composition in the hardened state, and thus to improve the durability of the hydraulic composition and decrease corrosion of metal reinforcements.

The present invention makes it possible to access a hydraulic composition with improved durability which has one or more of the following characteristics:

the hydraulic composition has improved carbonation resistance;

the metal reinforcements present in the hydraulic composition are little or not corroded;

corrosion of metal reinforcements can be delayed when this happens;

the coating (as defined in the NF EN 1992-1-1 standard of October 2005, paragraph 4.4.1.1) of the reinforcements becomes less critical and positioning the reinforcements within the thickness of the hydraulic composition is facilitated;

the hydraulic composition can comprise a reduced clinker level, without corrosion of metal reinforcements being promoted;

the hydraulic composition enables a barrier to other gases than CO₂ (for example radon, chlorine, and oxygen), as well as a barrier to liquids to be formed.

The present invention is particularly applicable to reinforced concretes, in particular reinforced concretes based on hydraulic composition having a low clinker level.

According to an alternative of the invention, the composition of the invention is such that it consists of said hydraulic binder and one or more polyalkyleneimine(s).

According to this alternative, a composition according to the invention designates more precisely a so-called hydraulic binder composition.

Conventionally, by “hydraulic binder” it is meant a dry material which sets and hardens by hydration. Setting is switching from liquid or pasty state to solid state. Setting is followed or accompanied with a hardening phenomenon during which the material requires mechanical properties. Hardening generally occurs at the end of setting, particularly for cements.

A hydraulic binder generally comprises a clinker, calcium sulphate, and one or more mineral addition(s), in particular as detailed hereinafter.

The invention thus more particularly aims at a hydraulic binder further comprising a clinker, at least one polyalkyleneimine in accordance with the invention, and possibly one or more mineral addition(s).

According to another alternative of the invention, a composition according to the invention further comprises water.

According to this alternative, the composition of the invention designates more precisely a so-called hydraulic composition.

Conventionally, by “hydraulic composition” it is meant a composition comprising a hydraulic binder, water, possibly in the hardened state, metal elements, possibly granulates and possibly adjuvants. Preferably, the hydraulic composition of the invention is a concrete, more particularly a reinforced concrete.

The amount of water is such that the mass ratio water/binder is preferably from 0.3 to 0.8 and preferentially from 0.4 to 0.7.

A hydraulic composition according to the invention both includes compositions in the fresh state, for example a cement grout, and in the hardened state, for example a mortar or a concrete. One skilled in the art understands that the hydraulic composition in the fresh state comprises water used for hydrating the binder, whereas the hydraulic composition in the hardened state is obtained after hydration to give concrete or mortar.

Polyalkyleneimines

The composition according to the invention comprises at least one branched polyalkyleneimine.

Unexpectedly, the hydraulic composition of the invention, which incorporates at least one polyalkyleneimine, has a higher carbonation resistance than a reference hydraulic composition free of polyalkyleneimine, which makes it possible to improve the durability of said hydraulic composition and to decrease corrosion of possible metal reinforcements.

Indeed, as is evident from the examples described hereinafter, the presence of one or more polyalkyleneimine(s) in a hydraulic composition surprisingly turns out to be particularly beneficial to decrease the carbonation velocity in said composition.

The polyalkyleneimine(s) of the hydraulic composition of the invention has (have) a molecular weight between 400 g/mol and 1,000,000 g/mol, preferably between 600 g/mol and 200,000 g/mol, preferentially between 800 g/mol and 50,000 g/mol, for example between 1,000 g/mol and 5,000 g/mol. By “molecular weight”, it is meant a weight average molecular weight (Mw).

The polyalkyleneimine(s) is (are) present in the composition at a mass ratio between 0.05% and 5,0% relative to the binder mass.

Preferably, the mass ratio of polyalkyleneimine(s) relative to the binder is between 0.1% and 4.0%, preferentially between 0.15% and 3.0%, or even between 0.2% and 1.5%.

The nitrogen content (dry %) of the polyalkyleneimines is advantageously between 15% and 33%.

The composition of the invention can comprise a mixture of several polyalkyleneimines.

As a polyalkyleneimine, polyethyleneimine or polypropyleneimine can be mentioned.

Preferably, the composition according to the invention comprises at least one polyethyleneimine, preferentially a branched polyethyleneimine.

According to one embodiment, the composition of the invention comprises at least one branched polyalkyleneimine.

Branched polyalkyleneimines contain primary, secondary, and tertiary amines.

It can be in particular a branched polyethyleneimine or a branched polypropyleneimine.

Branched polyethyleneimines are generally obtained by polymerising ethyleneimine (also called aziridin).

As a branched polyalkyleneimine, dendrimeric polyethyeneimines (dendrimeric PEI) and dendrimeric polypropyleneimines (dendrimeric PPI) can be mentioned. These compounds have an alkylenediamine type nucleus and are generated as a tree (“a star”) about this nucleus, by stacking successive generation layers. These compounds mainly comprise primary amines (in the periphery) and tertiary amines (in the centre).

According to one embodiment, the polyalkyleneimine(s) is (are) present in the composition of the invention in a free form, for example in an aqueous solution.

Clinker

The clinker used according to the present invention can be a Portland clinker, a sulpho-aluminous clinker, an aluminous clinker, a belite clinker, a sulpho belite clinker and mixtures thereof, preferably a Portland clinker.

A Portland clinker is obtained by clinkering at high temperature a mixture comprising in particular limestone and clay. For example, a Portland clinker is a clinker as defined in the NF EN 197-1 standard of February 2001.

The mass proportion of clinker in the hydraulic binder can be between 0% and 100% relative to the binder mass, preferably between 5% and 95%, more preferentially between 30% and 85%.

As previously discussed, the invention is particularly interesting for hydraulic compositions having a low clinker level.

For the purposes of the invention, a low clinker level means a mass clinker level in the hydraulic binder lower than 85%.

Thus, the reduced clinker amount is usually compensated in the hydraulic binder by mineral additions, such as for example a limestone filler described hereinafter.

Mineral Addition

Mineral additions are generally materials usable as a partial substitute for clinker.

The mineral additions that are suitable for the hydraulic binder according to the invention can be chosen from slags (for example as defined in the NF EN 197-1 standard of February 2001, paragraph 5.2.2), natural or artificial pozzolans (for example as defined in the NF EN 197-1 standard of February 2001, paragraph 5.2.3), fly ash (for example as defined in the NF EN 197-1 standard of February 2001, paragraph 5.2.4), calcinated shales (for example as defined in the NF EN 197-1 standard of February 2001, paragraph 5.2.5), calcium carbonate based mineral additions, for example limestone (for example as defined in the NF EN 197-1 standard of February 2001, paragraph 5.2.6), silica fumes (for example as defined in the NF EN 197-1 standard of February 2001, paragraph 5.2.7), metakaolins, biomass ash (for example rice husk ash) and mixtures thereof.

The mineral additions used according to the invention can also be ash from plant combustion, for example ash from combusting rice hulls.

The mineral additions used according to the invention can also be zeolites.

A fly ash is generally a powdery particle included in the fumes of coal-fired power plants. It is generally recovered by electrostatic or mechanical precipitation.

The chemical composition of a fly ash mainly depends on the chemical composition of the coal burnt and the method used in the thermal power plant it comes from. The same is true for its mineralogical composition. The fly ash used according to the invention can be of a siliceous or calcareous nature.

Preferably, the fly ash used according to the present invention is chosen from those described in the NF EN 197-1 European standard of February 2001.

Slags are generally obtained by quickly cooling the molten slag from melting the iron ore in a blast furnace.

The slags used according to the present invention can be chosen from blast furnace granulated slags according to the NF EN 197-1 European standard of February 2001 paragraph 5.2.2.

The silica fumes used according to the present invention can be a material obtained by reducing high purity quartz by coal in electric arc ovens used for producing silicon and ferrosilicon alloys. Silica fumes are generally formed by spherical particles comprising at least 85% of amorphous silica.

Preferably, the silica fumes used according to the present invention are chosen from the silica fumes according to the NF EN 197-1 European standard of February 2001 paragraph 5.2.7.

The pozzolan materials used according to the present invention can be siliceous or silico-aluminous natural substances, or a combination thereof. Among pozzolan materials, natural pozzolans, which are generally materials of volcanic origin or sedimentary rocks, and calcinated natural pozzolans, which are materials of volcanic origin, clays, shales or sedimentary rocks, being thermally activated, can be mentioned. The pozzolan materials used according to the invention can be chosen from pumices, tuffs, scoria or mixtures thereof.

Preferably, the pozzolan materials used according to the present invention are chosen from the pozzolan materials according to the NF EN 197-1 European standard of February 2001 paragraph 5.2.3.

Preferably, the mineral additions used according to the invention are calcium carbonate containing materials, for example limestone (also called limestone filler).

The calcinated clays used according to the present invention can result from calcinating a clay, kaolinite, associated with different minerals (phyllosilicates, quartz, iron oxides) in variable proportions depending on deposits. They can be obtained either by grinding calcination or by calcination grinding in production units with rotary kilns, with trays or by so-called “flash” calcination, for example. They are essentially composed of amorphous alumina silicate particles.

Preferably, the calcinated clays used according to the present invention can be chosen from the metakaolins according to the PR NF P 18-513 proposed draft standard of December 2011.

According to an alternative, the hydraulic binder of the invention can further comprise calcium sulphate.

The calcium sulphate used includes gypsum (calcium sulphate dihydrate, CaSO₄.2H₂O), semi-hydrate (CaSO₄.1/2H₂O), anhydrite (anhydrous calcium sulphate, CaSO₄) or mixtures thereof. Gypsum and anhydrite exist in the natural state. It is also possible to use a calcium sulphate which is a by-product of some industrial processes.

Generally, the hydraulic binder of the invention comprises from 3% to 28% by mass of calcium sulphate with respect to the clinker mass.

A high calcium sulphate content is generally adopted for aluminous and sulpho-aluminous cements. The chemical nature (gypsum, semi-hydrate or anhydrite) and the calcium sulphate dose are advantageously adjusted as a function of the cement to avoid hydrate swelling.

In the case where the clinker is a Portland clinker, the hydraulic binder of the invention comprises from 1% to 8%, preferably from 2% to 5% mass of calcium sulphate with respect to the clinker mass.

A binder according to the invention is generally obtained by co-grinding a clinker and a calcium sulphate.

### Metal Elements

The composition of the invention, in particular the hydraulic composition of the invention, can comprise in the hardened state metal elements, as for example reinforcements, in particular reinforcements for reinforced concrete according to the NF EN 1992-1-1 European standard of October 2005.

The reinforcements can be in the form of bars, welded meshs or rod assemblies, setting reinforcements. The junctions of bars can be ensured by covering, by a jointing device, by welding, by wire tie, by crimping or any other means.

According to an alternative of the invention, the metal elements are drawn steel fibres fully or partially replacing ordinary metal reinforcements in some applications (pavings, shotcrete or repair concrete).

### Granulates

The composition of the invention, in particular the hydraulic composition of the invention, can comprise granulates.

The granulates possibly used in the composition according to the invention include sand (the particles of which have generally a maximum size (Dmax) lower than or equal to 4 mm), and possibly crushed stones (the particles of which have generally a minimum size (Dmin) higher than 4 mm and preferably a Dmax lower than or equal to 20 mm). The granulates used in the composition according to the invention are generally in accordance with the NF EN 12620 European standard of August 2003, and are of natural or artificial origin. The granulates can also be wood.

### Adjuvants

The composition of the invention, in particular the hydraulic composition of the invention, can comprise conventional adjuvants with the proviso that they are compatible with the polyalkyleneimines required according to the invention.

The adjuvants usable in the hydraulic composition according to the invention can for example be one of those described in the European standards NF EN 934-2 of September 2002, NF EN 934-3 of November 2009 or NF EN 934-4 of August 2009. Advantageously, the hydraulic composition according to the invention comprises at least one adjuvant for a hydraulic composition: an accelerator, an air entraining agent, a viscosifier, a retarder, a clay inerting agent, an antifoam agent, a plasticizer and/or a superplasticiser.

Preferably, the hydraulic composition according to the invention comprises at least one antifoam agent avoiding air entrainment in the composition.

Clay inerting agents are compounds which enable deleterious effects of clays on the properties of hydraulic binders to be reduced or prevented. The clay inerting agents include those described in WO 2006/032785 and WO 2006/032786.

The term “superplasticiser” as used in the present description and the accompanying claims is to be understood as including both water reducers and the superplasticisers as described in the book entitled “Concrete Admixtures Handbook, Properties Science and Technology”, V.S. Ramachandran, Noyes Publications, 1984.

A water reducer is defined as an adjuvant which typically reduces by 10% to 15% the mixing water amount for a concrete with regard to a given workability. Water reducers include, for example, lignosulphonates, hydrocarboxylic acids, carbohydrates and other special organic compounds, for example glycerol, polyvinyl alcohol, sodium alumino-methyl-siliconate, sulphanilic acid and casein.

Superplasticisers belong to a new class of water reducers, being chemically different from normal water reducers and capable of reducing water amount by about 30%. Superplasticisers have been globally classified into four groups: sulphonated naphthalene formaldehyde (SNF) condensates (generally a sodium salt); sulphonated melamine formaldehyde (SMF) condensates; modified lignosulphonates (MLS); and the others. More recent superplasticisers include polycarboxylic compounds like polycarboxylates, for example polyacrylates. A superplasticiser is preferably a new generation superplasticiser, for example a copolymer containing a polyethylene glycol as a grafted chain and carboxylic functions in the main chain as a polycarboxylic ether. Sodium polycarboxylate-polysulphonate and sodium polyacrylates can also be used. Phosphonic acid derivatives, sodium polycarboxylate-polysulphonates and sodium polyacrylates can also be used. The necessary superplasticiser amount generally depends on the cement reactivity. The lower the reactivity, the lower the necessary superplasticiser amount. To reduce the total amount of alkaline salts, the superplasticiser can be used as a calcium salt rather than as a sodium salt.

Other additives can be incorporated in the composition according to the invention, for example, an antifoam agent (for example polydimethylsiloxane; triisobutylphosphonate). Antifoam agents can also be silicons as a solution, a solid or preferably a resin, oil or emulsion, preferably in water. Silicons comprising (RSiO_{0.5}) and (R₂SiO) are more particularly adapted.

In these formulae, the radicals R, which can be identical or different, are preferably a hydrogen atom or an alkyl group with 1 to 8 carbon atoms, the methyl group being preferred. The number of units is preferably from 30 to 120.

The amount of such an agent in the final cement is generally of at most 5 weight parts with respect to the cement.

According to one preferred embodiment, a composition according to the invention can comprise:

a hydraulic binder comprising a Portland clinker, calcium sulphate and a limestone filler or another mineral addition, the mass clinker proportion in the binder being between 30% and 85%,

at least one branched polyalkyleneimine with a molecular weight between 400 g/mol and 1,000,000 g/mol, preferably between 600 g/mol and 200,000 g/mol, preferentially between 800 g/mol and 50,000 g/mol, for example between 1,000 g/mol and 5,000 g/mol, at a mass proportion between 0.05% and 5.0 mass % with respect to said hydraulic binder,

water, at a proportion such that the mass ratio water/binder is between 0.3 and 0.8 and preferentially between 0.4 and 0.7,

possibly a granulate such a sand, and

possibly an antifoam agent.

The present invention also deals with a method for manufacturing a composition according to the invention, comprising a step of contacting at least one hydraulic binder, comprising at least one clinker, with at least one branched polyalkyleneimine, having a molecular weight from 400 g/mol to 1 000 000 g/mol, at a weight ratio polyalkyleneimine(s)/binder between 0.05% and 5.0%.

Preferably, in particular when the composition prepared is a hydraulic composition, the hydraulic binder and the polyalkyleneimine(s) are contacted in the presence of water.

The hydraulic composition according to the invention can be used directly on the worksite in the fresh state and cast in a formwork suitable for the intended application, or used in precast factory.

Mixing the hydraulic composition with water can be made according to methods known to one skilled in the art.

Thus, the polyalkyleneimine(s) can be added to water or to one of the components of the hydraulic composition according to the present invention, for example to the hydraulic binder or to the granulates.

The polyalkyleneimine(s) can be added at any time when manufacturing the hydraulic composition in the fresh state according to the invention, as a solid or liquid.

According to a preferred embodiment, the polyalkyleneimine(s) is (are) implemented as an aqueous solution.

This embodiment is particularly adapted to the case of water soluble polyalkyleneimine(s) with a basic pH, as is the case of branched polyalkyleneimines.

### Use

The present invention also deals with the use of at least one branched polyalkyleneimine, having a molecular weight between 400 g/mol and 1,000,000 g/mol, to reduce and/or prevent carbonation within a hydraulic composition comprising a hydraulic binder, said polyalkyleneimine(s) being present in the hydraulic composition at a weight ratio polyalkyleneimine(s)/binder between 0.05% and 5.0%.

The present invention more particularly deals with the use of at least one branched polyalkyleneimine, having a molecular weight between 400 g/mol and 1,000,000 g/mol, in association with a hydraulic binder in a hydraulic composition in the fresh state, said polyalkyleneimine(s) being present in the hydraulic composition at a weight ratio polyalkyleneimine(s)/binder between 0.05% and 5.0%, to reduce and/or prevent carbonation within said hydraulic composition in the hardened state.

### Shaped Object

The composition according to the present invention can be shaped to produce, after hydrating and hardening, a shaped object for the construction field.

The invention also deals with such a shaped object, obtained from a composition according to the present invention, in particular a hydraulic composition according to the present invention.

The shaped objects for the construction field include, for example, a floor, a screed, a foundation, a wall, a partition wall, a ceiling, a beam, a work top, a pillar, a bridge pier, a concrete or cement block, a piping, a post or pole, a staircase, a panel, an eaves, a mould, a road element (for example a road kerb), or a coating (for example for a road or a wall).

In the present description, including the accompanying claims, the percentages are expressed by mass, unless otherwise specified.

The following examples illustrate the invention in practice.

### EXAMPLES

### Example 1

### Preparation of Cylindrical Mortar Specimens

Cylindrical mortar specimens have been prepared from a hydraulic composition comprising a low clinker level hydraulic binder (substituted by 35% of a limestone filler). The water/binder ratio is 0.55 and the TiBP, TrilsoButyl Phosphate (antifoam agent) dose is 0.09%/binder.

The composition of the test pieces is indicated in table 1 and characteristic of the cement and sand are indicated in tables 2 and 3.

TABLE 1

| | | | Solid | Mass of a |
|---|---|---|---|---|
| | | | content | concrete |
| | Raw materials | density | (%) | mix (g) |
| Hydraulic | Portland cement | 3.1 | 100 | 552.6 |
| binder | CEM I 52.5 N CE CP2 NF | | | |
| | Limestone filler | 2.7 | 100 | 297.6 |
| | Betocarb HP St Beat provided | | | |
| | by the OMYA company | | | |
| | (density = 2.7) | | | |
| | Total binder | | | 850.2 |
| Sand | Standard sand | 2.63 | 100 | 2,700 |
| Water | Pre-wetting water | 1 | 0 | 162 |
| | (tap water at 20° C.) | | | |
| | Mixing water | 1 | 0 | 317 |
| | (tap water at 20° C.) | | | |
| Adjuvants | TriisoButylPhosphate (TiBP) | 0.965 | 99 | 0.8 |
| | (antifoam agent) | | | |
| | Branched PEI | | | |
| Total | | | | 4,030 |

TABLE 2
Characteristics of the CEM I 52.5 N CE CP2 NF,
Saint Pierre La Cour

| | | |
|---|---|---|
| Total K₂O | 1.08 | % |
| Total Na2O | 0.24 | % |
| Soluble K₂O | 0.85 | % |
| Soluble Na₂O | 0.1 | % |
| SiO₂ | 20.07 | % |
| Al₂O₃ | 4.95 | % |
| Fe₂O₃ | 2.96 | % |
| CaO | 63.89 | % |
| MgO | 0.89 | % |
| K₂O | 1.06 | % |
| Na₂O | 0.25 | % |
| SO₃ | 3.41 | % |
| TiO₂ | 0.19 | % |
| Mn₂O₃ | 0.14 | % |
| P₂O₅ | 0.27 | % |
| Cr₂O₃ | 0.02 | % |
| ZrO₂ | 0.02 | % |
| SrO | 0.02 | % |
| PAF | 1.56 | % |
| Total | 99.7 | % |
| Free CaO | 1.59 | % |
| Insolubles | 0.32 | % |
| SO₃ Horiba | 3.39 | % |

Cement model granulo laser curve

| | | |
|---|---|---|
| D10 | 2.79 | μm |
| D50 | 14.35 | μm |
| D90 | 43.92 | μm |
| D(4.3) | 19.6 | μm |
| Density of a solid- | 3.12 | g/cm³ |
| Physics | | |
| Specific surface area | 3,750 | cm²/g |
| BLAINE - Physics | | |
| Mono alite | 60 | % |
| Belite | 17.8 | % |
| Ferrite | 9.3 | % |
| Cubic aluminate | 4.4 | % |
| Ortho aluminate | 3 | % |
| Lime CaO | 0.2 | % |
| Portlandite Ca(OH)2 | 1.5 | % |
| Periclase | 0 | % |
| Arcanite | not calc | % |
| Quartz | 0 | % |
| Calcite | 0.8 | % |
| Gypsum | 0.5 | % |
| Semi-hydrate | 2.4 | % |
| Anhydrite | 0 | % |
| Dolomite | not calc | % |
| Phase X | not calc | % |
| Gypsum (by DSC) | 0.4 | % |
| Semi hydrate (by DSC) | 3 | % |
| Total CO₂ | 0.24 | % |
| Total H₂O | 1.01 | % |
| Atmosphere | Nitrogen | unitless |

TABLE 3
Characteristics of the standard stand
(EN 12620)

| | Unit | Value |
|---|---|---|
| Characteristics (EN 12620) | | |
| Vibrated compactness | | 0.696 |
| Adsorption coefficient | % | 0.42 |
| Real density | t/m³ | 2.63 |
| Methylene blue value | g/kg | 0 |
| Particle size (EN 12620) | | |
| Passing through 4 mm | % | 100 |
| Passing through 2.8 mm | % | 100 |
| Passing through 2.5 mm | % | 100 |
| Passing through 2 mm | % | 99 |
| Passing through 1 mm | % | 70.62 |
| Passing through 500 μm | % | 30.95 |
| Passing through 250 μm | % | 19.15 |
| Passing through 125 μm | % | 7.84 |
| Passing through 63 μm | % | 0 |

The branched polyethyleneimines (PEI) of table 4 have been used in various (mass) proportions with respect to the hydraulic binder.

TABLE 4

| | | Molecular | Solid | Nitrogen | Carbon |
|---|---|---|---|---|---|
| | | weights | content | content | content |
| Name | Supplier | (g/mol) | (%) | (% solids) | (% solids) |
| PEI600 | Sigma- | 600 | 99 | 25.9 | 55.9 |
| | Aldrich | | | | |
| Lupasol | BASF | 1,300 | 49 | 27.0 | 59.0 |
| G20 (PEI1300) | | | | | |
| Lupasol | BASF | 5,000 | 49 | 25.7 | 60.2 |
| G100 (PEI5000) | | | | | |
| PEI25000 | Sigma- | 25,000 | 99 | 23.9 | 57.9 |
| | Aldrich | | | | |
| PEI600000 | Sigma- | 600,000 | 50 | 26.3 | 64.1 |
| | Aldrich | | | | |

### Preparation Protocol

The sand has been put in the bowl of a 32 type Perrier kneader with pre-wetting water. Mixing has started and has been maintained at a low speed for 1 minute.

Mixing has then been stopped for 4 minutes.

The hydraulic binder (clinker +filler) has been added and mixing has been resumed at a low speed for 1 minute.

The mixing water, comprising the adjuvants (branched polyethylemeneimine and antifoam), has then been added within 30 seconds while mixing at a low speed.

The mixture has been mixed at a high speed for 1 minute, to obtain a mortar.

The mortar has then been cast in polystyrene moulds with dimensions 4 cm×4 cm×16 cm (without vibration), in order to obtain 6 concrete test pieces (demould released after 24 h at 20° C. at 100% relative humidity).

### Example 2

### Measurement of Carbonation of the Cylindrical Mortar Specimens

### Measurement Protocol

The cylindrical mortar specimens have then been placed under accelerated carbonation conditions.

After 6 days of curing in a wet cabinet at 100% relative humidity and 20° C., the test pieces have been put in a carbonation box (PEHD rectangular vessel, 576 litres capacity, provided with a sealed lid), the atmosphere of which has been enriched with CO₂ (10%+/−0.5% CO₂ in the air volume of the box), 20° C.+/−1° C. and 65%+/−5% of relative humidity.

The temperature control has been ensured by the fact that the box is disposed in a laboratory controlled at 20+/−1° C. The relative humidity rate has been controlled by a vat filled with a water-saturated ammonium nitrate salt, this vat being positioned in the bottom of the box, on the entire available surface. For the CO₂, the box has been connected to a network supplied with bottles filled with a 50% CO₂/50% pressurised nitrogen mixture. An expansion station enabled the mixture to be delivered at 1 bar of relative pressure in the network. The gas introduction has been automatically managed by a CO₂ gas analyser which continuously analysed the box atmosphere (wall analyser, brand ABISS, model LMP 320, provided by the PBI Datasensor company). At each gas introduction, another solenoid valve opened to discharge extra gas to a crawl space external to the laboratory, in order to avoid any overpressure in the box. A fan continuously operated to have homogeneous CO₂ gas distribution in the box atmosphere.

At different points in time (at 2, 3, 4, 7, 13, 14, 28, and at 35 days), the test pieces have been removed from the carbonation box and slit using a hydraulic stone cutter for determining the carbonation depth.

The carbonation resistance has been estimated by measuring the carbonation rate of the test pieces. The higher this rate, the lesser resistant to a carbonation the concrete, and the higher the corrosion risk of the structure reinforcements. This rate has been measured by determining the depth of carbonated concrete after different exposition periods of the test pieces in the box enriched with CO₂ gas. The material is considered as carbonated when its pH is lower than or equal to 9. This has been viewed by spraying a 0.5% phenolphthalein solution diluted in a mixture comprised of 50% demineralised water and 50% ethanol. Phenolphthalein is a colour indicator which turns purple pink when the pH is higher than 9 and remains colourless when the pH is lower than 9. Carbonated concrete zones are thus those which remain colourless after spraying the phenolphthalein suspension. The carbonated concrete and mortar depths have been measured at several zones. The arithmetic mean of the values obtained has been calculated.

The carbonation rate is expressed in mm/day^{1/2}. It is the slope of the straight line obtained when the evolution of the carbonation depth (in mm) versus the square root of time (in days) is represented.

### Results

The results of the measurement of the carbonation rate (mm/day^{1/2}) as a function of the proportion (%/binder) and the molecular weight (g/mol) of PEI are indicated in table 5:

TABLE 5

| | Molecular weight of the PEIs (g/mol) | | | | |
|---|---|---|---|---|---|
| PEI/binder (%) | 600 | 1,300 | 5,000 | 25,000 | 600,000 |
| 0 (reference) | 3.1 | 3.1 | 3.1 | 3.1 | 3.1 |
| 0.25 | 3.1 | 2.5 | 2.7 | 2.8 | 2.8 |
| 0.5 | 3.1 | 2.1 | 2.6 | 2.6 | 2.7 |
| 1 | 3 | 2 | 2.4 | 2.5 | 2.5 |
| 2 | | 1.7 | 1.7 | 1.7 | |
| 5 | 2.9 | | 1.6 | 1.6 | 1.9 |

All the PEIs and doses with respect to the binder resulted in reduced carbonation rates with respect to the reference without PEI.

It has been observed that the carbonation rate decreases when the mass proportion of PEI with respect to the binder increases.

1-13. (canceled)

14. A composition comprising:
an hydraulic binder comprising at least one clinker, and
at least one branched polyalkyleneimine, having a molecular weight between 400 g/mol and 1 000 000 g/mol, at a weight ratio polyalkyleneimine(s)/binder between 0.05% and 5.0%.

15. The composition according to claim 14, wherein the composition consists of said hydraulic binder and one or more polyalkyleneimine(s).

16. The composition according to claim 14, further comprising water.

17. The composition according to claim 16, wherein a mass ratio water/binder is between 0.3 and 0.8.

18. The composition according to claim 14, further comprising metal elements.

19. The composition according to claim 18, wherein the metal elements are reinforcements.

20. The composition according to claim 14, wherein the polyalkyleneimine is a polyethyleneimine or a polypropyleneimine.

21. The composition according to claim 14, wherein the polyalkyleneimine is a polyethyleneimine.

22. The composition according to claim 14, wherein the clinker is a Portland clinker.

23. The composition according to claim 14, wherein the mass proportion of clinker in the hydraulic binder is between 5% and 95% relative to the mass of said binder.

24. The composition according to claim 14, wherein the mass proportion of clinker in the hydraulic binder is between 30% and 85%, relative to the mass of said binder.

25. The composition according to claim 14, wherein the weight ratio polyalkyleneimine(s)/binder is between 0.1% and 4.0%.

26. The composition according to claim 25, wherein the weight ratio polyalkyleneimine(s)/binder is between 0.15% and 3.0%.

27. The composition according to claim 26, wherein the weight ratio polyalkyleneimine(s)/binder is between 0.2% and 1.5%.

28. The composition according to claim 14, wherein the weight ratio polyalkyleneimine(s)/binder is between 0.15% and 3.0%.

29. The composition according to claim 14, wherein the hydraulic binder further comprises at least one mineral addition.

30. The composition according to claim 29, wherein said at least one mineral addition is chosen from the group consisting of slags, pozzolans, fly ash, calcinated shales, calcium carbonate based materials, silica fumes, metakaolins, biomass ash and mixtures thereof.

31. A method for manufacturing a composition according to claim 14, comprising a step of contacting at least one hydraulic binder, comprising at least one clinker, with at least one branched polyalkyleneimine, having a molecular weight from 400 g/mol to 1 000 000 g/mol, at a weight ratio polyalkyleneimine(s)/binder between 0.05% and 5.0%.

32. The method for manufacturing a composition according to claim 14, wherein the polyalkyleneimine(s) is (are) implemented as an aqueous solution.

33. A method comprising utilizing at least one branched polyalkyleneimine, having a molecular weight between 400 g/mol and 1,000,000 g/mol, for reducing and/or preventing carbonation within a hydraulic composition comprising at least one hydraulic binder, said polyalkyleneimine(s) being present in the hydraulic composition at a weight ratio polyalkyleneimine(s)/binder between 0.05% and 5.0%.

34. An object shaped for the construction field obtained from a composition according to claim 14.
